(19) United States
(12) Patent Application Publication
(10) Pub. No.: US 2024/0359136 A1
(43) Pub. Date: Oct. 31, 2024

(54) METHOD FOR MONITORING A FILTRATION PROCESS

(71) Applicant: GLOBAL LIFE SCIENCES SOLUTIONS GERMANY GMBH, Dassel (DE)

(72) Inventors: Till Briskot, Karlsruhe (DE); Nils Hillebrandt, Karlsruhe (DE); Tobias Hahn, Karlsruhe (DE); Thiemo Huuk, Karlsruhe (DE); Jürgen Hubbuch, Pfinztal (DE)

(21) Appl. No.: 18/560,264

(22) PCT Filed: May 9, 2022
(86) PCT No.: PCT/EP2022/062448

§ 371 Date: Nov. 10, 2023

(30) Foreign Application Priority Data
May 11, 2021 (EP) 21173247.4

(51) Int. Cl. B01D 61/22

(52) U.S. Cl. CPC B01D 61/22; B01D 2313/701

(57) ABSTRACT

In at least one embodiment, the method for monitoring a filtration process in which a first solution is processed by a filter system (100) comprises: —receiving first measurement data which are indicative for at least one input process variable (V1_M, V2_M), wherein the at least one input process variable (V1_M, V2_M) is a process variable of the filtration process measurable during the filtration process with help of a measurement unit (11, 31), —determining output data by executing a filtration process model (4) and using the first measurement data, wherein—executing the filtration process model (4) comprises solving at least one physical equation describing the interaction between solutes of the first solution, —at least one parameter of the filtration process model (4) is dependent on the at least one input process variable (V1_M, V2_M) derived from the first measurement data, —the output data is indicative for at least one modeled process variable (V3_P, V4_P) of the filtration process.

A method for monitoring a filtration process is specified. Moreover, a device, a computer program, a computer-readable data carrier, and a filter system are specified.

### BACKGROUND OF THE INVENTION

Biopharmaceutical active ingredients such as antibodies are produced in complex industrial bioprocesses. First, the target molecule, in the following also referred to as product, is produced in genetically modified cells. Then the product is usually purified by chromatography. After purification of the product by chromatography, a combined UFDF (ultrafiltration and diafiltration) process often represents the final production step. It allows the concentration of the product and transfer of the active pharmaceutical ingredient into the final formulation buffer.

To enable a subcutaneous administration of a drug to the patient, the biopharmaceutical industry always aims for a high product concentration at the end of, e.g., a UFDF process. This dosage form with high product concentration is beneficial to the patient but poses significant challenges for the development and operation of UFDF processes.

Due to interactions between the actual dissolved product and other dissolved excipients, a depletion of desired excipients and an accumulation of undesired excipients may occur in the solution during a UFDF process. This effect can cause that the finally obtained solution does not meet quality requirements. For an effective development and control of UFDF processes, it is therefore desirable that critical quality attributes of the solution, such as the concentration of specific excipients and/or the product, can be measured in real-time.

At this time, however, real-time quantification of quality attributes is limited to only a small number of attributes that can be measured directly using hardware sensors. These include the pH value and conductivity of solutions. The real-time determination of not directly measurable process variables, like concentrations, may be realized by a statistical evaluation of multivariate sensor signals. UV/Vis spectrometer and light scattering photometer may be used as such sensors. A disadvantage of the described methodology is, however, that the statistical evaluation is only valid within a limited process window and requires a complex set-up procedure for each product. Moreover, it only allows quantification and characterization of the product and does not include potentially critical excipients like buffer components. Since these excipients cannot be measured directly in the process, they have to be determined by means of complex offline analytics such as analytical chromatography. The term offline analytics characterizes a manual extraction of the sample to be analyzed, followed by sample preparation, measurement, and evaluation of the sample in a further laboratory. Due to the time between sampling and the availability of analytical results, a direct control and monitoring of processes is not possible based on offline measurements.

A possible real-time quantification of excipients and/or products may be done with a Fourier transform infrared spectrometer. As in the analytical technique described above, the real-time quantification is realized by a statistical evaluation of a multivariate sensor signal. The described real-time quantification requires that the excipients and/or products to be quantified can be detected in the infrared range. This requirement is not necessarily guaranteed for all substances. In addition, the evaluated signal of the sensor must have a sufficient signal-to-noise ratio, which is not always fulfilled due to the low concentration of many excipients. Since signal evaluation is performed using statistical models, the model has to be calibrated offline for each product-excipient combination and is only valid within the calibrated process range. Multivariate hardware sensors such as UV/Vis spectrometers, light scattering photometers, and Fourier transform infrared spectrometers are also rarely integrated into existing production facilities (filter systems), which complicates the implementation of the described approaches into real production facilities.

It should be noted that the above-made statements should not be construed as being admitted prior art. They are only made to illustrate the background of the presently disclosed concepts and may not have been made available to the public yet.

### DETAILED DESCRIPTION OF THE INVENTION

One object to be achieved is to provide an improved method for monitoring a filtration process. Preferably, the method allows to monitor the concentration of different solutes in a solution in real-time. Further objects to be achieved are to provide a device, a computer program, and a computer-readable data carrier configured to perform the method as well as a filter system with which the method can be performed.

These objects are achieved, inter alia, by the subject-matter of the independent claims. Advantageous embodiments and further developments are subject to the dependent claims and are also presented in the following description and the figures.

Firstly, the method for monitoring a filtration process is specified. During the filtration process, a first solution is processed by a filter system. Particularly, the first solution is filtered by using the filter system. The first solution may comprise at least one solute, i.e. one or more solutes. The first solution may be defined as a solution comprising at least one product as one solute and may therefore also be referred to as product solution. The product is, in particular, a biopharmaceutical active ingredient. The first solution may comprise, besides the at least one product, further solutes like excipients. The excipients may be used to stabilize the product(s) in the finally obtained first solution

In the filter process, the first solution may be guided to a filter module of the filter system. The filter module may comprise at least one membrane, e.g. a semipermeable membrane, which is permeable for some of the solutes of the first solution and/or the solvent of the first solution, but impermeable for the at least one product. The portion of the first solution permeating through the membrane is called the permeate. The portion of the first solution not passing through the membrane is called the retentate. The permeate may be removed from the first solution and may leave the filter system. The permeate does no longer constitute to the first solution. The retentate may remain in the filter system and may again be mixed to that portion of the first solution which has not yet been guided to the filter module. Since the retentate still comprises the at least one product, it is still part of the first solution. In the case that the whole initial first solution has been processed through the filter module, the retentate even completely replaces the initial first solution and forms the first solution. Therefore, the expressions retentate and first solution are herein used as synonyms. The retentate/first solution may then again be guided to the filter module and may again be filtered. This may be repeated several times or done continuously in order to increase the concentration of the at least one product in the first solution.

Due to the separation of the permeate not comprising the at least one product and the retentate comprising the at least one product, the composition of the first solution may change during the filtration process. Particularly, the amount of the excipients may change in the first solution. Additionally, during the filtration process, a second solution may be added or mixed to the first solution. The added portion of the second solution becomes part of the first solution. Thus, also this mixing changes the composition of the first solution.

According to at least one embodiment, the method comprises a step in which first measurement data are received. The first measurement data are indicative for at least one input process variable. The at least one input process variable may be a process variable of the filtration process measurable or measured during the filtration process with help of a measurement unit, e.g. in real-time and/or in-line. The input process variable is, e.g., extractable from the first measurement data. The at least one input process variable may be measured only once during the filtration process, e.g. at the beginning (t=0) of the filtration process, or repeatedly or continuously during the filtration process.

Here and in the following, a measurement unit may be a sensor, particularly an in-line hardware sensor of the filter system. A process variable may be a physical quantity which is characteristic for the filtration process. Receiving measurement data means, in particular, that the measurement data are received by an interface of a computer or processor.

According to at least one embodiment, the method comprises a step, in which output data are determined by executing a filtration process model and using the first measurement data. Thus, the output data are determined depending on the first measurement data and by executing the filtration process model. The filtration process model is, in particular, a model simulating the filtration process. For example, the filtration process model is a mathematical model. The filtration process model may, in particular, simulate interactions between some or all solutes in the first solution, e.g. by taking into account certain properties of the first solution. The filtration process model may be a mechanistic model and/or a first principle model. When executing the filtration process model, information of the first measurement data may be used in order to determine the output data.

According to at least one embodiment, executing the filtration process model comprises solving at least one physical equation. The at least one physical equation may describe the interaction between solutes, e.g. between all solutes, of the first solution. In particular, the physical equation may describe the interaction between the at least one dissolved product of the first solution and other solutes, like dissolved excipients in the first solution. The physical equation may be a scattering equation and/or a mean field equation. The described interaction between the solutes may be an electro-magnetic interaction.

Furthermore, the filtration process model may be chosen to take into account mass balance of the at least one product on the retentate side and/or electroneutrality condition on the retentate side and/or electroneutrality condition on the permeate side and/or electroneutrality condition in the second solution and/or thermodynamic equilibrium between the permeate and the retentate.

According to at least one embodiment, at least one parameter of the filtration process model, e.g. of the at least one physical equation, is dependent on the at least one input process variable derived from the first measurement data. In other words, for executing the model, the input process variable extracted from the first measurement data may be used in order to determine the at least one parameter of the filtration process model.

According to at least one embodiment, the output data is indicative for at least one modeled process variable of the filtration process. The modeled process variable is a process variable of the filtration process predicted or modeled, respectively, by the filtration process model. The modeled process variable may be extractable from the output data. The modeled process variable may represent a process variable of the filtration process which is measurable with help of a measurement unit, e.g. in-line or in real-time, or which cannot be measured in-line with help of a measurement unit or which can only be measured offline, respectively.

In at least one embodiment, the method for monitoring a filtration process in which a first solution is processed by a filter system comprises:
receiving first measurement data which are indicative for at least one input process variable, wherein the at least one input process variable is a process variable of the filtration process measurable during the filtration process with help of a measurement unit,
determining output data by executing a filtration process model and using the first measurement data, wherein
   executing the filtration process model comprises solving at least one physical equation describing the interaction between solutes of the first solution,
   at least one parameter of the filtration process model is dependent on the at least one input process variable derived from the first measurement data,
   the output data is indicative for at least one modeled process variable of the filtration process.

The present invention is, inter alia, based on the idea to model process variables with help of a filtration process model which appropriately takes into account the underlying physics of the filtration process. This is achieved by a filtration process model which solves one or more physical equations describing the interaction between solutes of the first solution and additionally using measurement data as an input to the filtration process model. Due to this, the filtration process model can be applied to solutions comprising different products and can be applied in a much wider process window than, e.g., statistical models. Moreover, with such a filtration process model, not only the actual state of the filtration process can be described but also past states can be reconstructed and/or future states can be predicted. Deviations in the filtration process from the desired filtration process can be detected at an early stage. Furthermore, the predictions of the filtration process model can be used to control the filtration process in order to counteract identified process deviations. A further advantage of the present invention is that the first measurement data can be obtained with univariate hardware sensors which can be implemented easily in filter systems.

According to at least one embodiment, the method comprises a step in which the output data are analyzed in order to adjust the filtration process when necessary. For example, when analyzing the output data, the at least one modeled process variable is compared to a reference process variable. If the deviation between the modeled process variable and the reference process variable exceeds a certain threshold, the filtration process may be adjusted, e.g. by controlling a controllable process parameter of the filtration process, e.g. by controlling an actuator of the filter system. The controllable process parameter may be the amount and/or (volumetric) flowrate of the permeate removed from the first solution. Additionally or alternatively, the at least one controllable process parameter may be the amount and/or (volumetric) flowrate of the second solution mixed to the first solution. Also, other controllable process parameters of the filtration process may be controlled in order to adjust the filtration process, e.g. the temperature of the first and/or second solution and/or the duration of different steps of the filtration process. If the deviation between the modeled process variable and the reference process variable is below the certain threshold, the filtration process may not be adjusted.

According to at least one embodiment, the output data is indicative for the time dependency of the at least one modeled process variable. In other words, the time dependency of the at least one modeled process variable is modeled with the filtration process model. Particularly, the output data may be indicative for the future development of the modeled process variable. Thus, the filtration process model may predict how the modeled process variable develops or changes in the future, e.g. from the current state to the end of the filtration process.

According to at least one embodiment, determining the output data is done during the filtration process. Additionally or alternatively, determining the output data is done in real-time.

Particularly, the output data is obtained before the filtration process has been finished. Preferably, the output data is determined during the same filtration process during which the input process variable is measured. For example, a time window between measuring the at least one input process variable with help of a measurement unit and the determination of the output data is at most 1 minute or at most 10 seconds or at most 1 second.

According to at least one embodiment, the at least one physical equation is based on or is derived from or is the Poisson-Boltzmann equation. Additionally or alternatively, the filtration process model is based on a cell model approach. For example, the Poisson-Boltzmann equation on the retentate side is solved. The Poisson-Boltzmann equation may be solved numerically.

When using a spherical cell model approach, the Poisson-Boltzmann equation may be formulated as follows:

$$\frac{{\partial }^{2} ψ ( r )}{\partial {r}^{2}} + \frac{2}{r} \frac{\partial ψ ( r )}{\partial r} = - \frac{e}{ε {ε}_{0}} {\sum }_{i} {\overline{c}}_{i} {z}_{i} exp ( - \frac{{z}_{i} e}{{k}_{b} T} ( ψ ( r ) - \overline{ψ} ) )$$

wherein ψ is the electrostatic potential at radius r, ε is the relative permittivity, and ε₀ is the vacuum permittivity. r denotes the radius relative to the center of the cell. The cell may be a Wigner-Seitz cell. c̅ᵢ is the average microion concentration in the cell volume and zᵢ is the charge of the corresponding microion. ψ̅ denotes the average electrostatic potential in the Wigner-Seitz cell. k_{b} represents the Boltzmann constant, and T is the temperature.

According to at least one embodiment, the model assumes Donnan equilibrium in the filter module. Particularly, the filter module comprises a semipermeable membrane.

According to at least one embodiment, in the cell model approach, the first solution is reduced to a single Wigner-Seitz cell. For example, the Wigner-Seitz cell contains one molecule, particularly only one molecule, of the product. For example, this molecule is located in the center of the cell.

According to at least one embodiment, the radius R_{WS} of the Wigner-Seitz cell is defined by the concentration of the product c_{M} in the first solution and may be

$${R}_{ws} = {( \frac{3}{4 π {N}_{A} {c}_{M}} )}^{\frac{1}{3}}$$

wherein N_{A} is the Avogadro constant. The Wigner-Seitz cell may be a spherical Wigner-Seitz cell. Alternatively, the Wigner-Seitz cell may be of non-spherical shape, e.g. cylindrical or cubic shape.

By using this formula for the radius of the Wigner-Seitz cell, the Poisson-Boltzmann equation can be solved very efficiently which reduces the computational time and thus allows a real-time determination of the output data.

According to at least one embodiment, the at least one input process variable is the pH value of the first solution and/or of the second solution mixed to the first solution during the filtration process. For example, the pH value of the first solution measured at the beginning of the filtration process (at time t=0) may be used as a first input process variable. The pH value of the second solution measured once ore continuously or repeatedly during the filtration process, e.g. during mixing to the first solution, may be used as a second input process variable.

According to at least one embodiment, at least one further parameter of the filtration process model, e.g. of the at least one physical equation, is dependent on the composition of the first solution and/or of the second solution mixed to the first solution during the filtration process. Additionally or alternatively, the at least one further parameter of the filtration process model is dependent on the charge and/or surface charge density of a solute, e.g. of the at least one product, in the first solution. It is also possible that the at least one further parameter of the model is indicative for the interaction between solutes, e.g. between the at least product and other solutes.

The at least one further parameter of the model may be predetermined. For example, the at least one further parameter of the model is not measured during the filtration process and/or is determined offline. For example, the at least one further parameter is guessed or calculated or determined before starting the filtration process. The at least one further parameter may, however, be validated during the method and/or during previous filtration processes. For example, the at least one further parameter of the model is adjusted during the method, e.g. when a modeled process variable extracted from the output data deviates from a reference process variable by more than a certain threshold. For example, the concentration of at least one product or another solute in the first solution at the beginning of the filtration process (at time t=0) may be determined offline. Additionally or alternatively, the concentration of a solute in the second solution at t=0 may be determined offline.

According to at least one embodiment, the at least one modeled process variable extractable from the output data is the concentration of a solute of the first solution and/or of a solute of the permeate of the filtration process. For example, the at least one modeled process variable extractable from the output data is the concentration of the at least one product in the first solution. Additionally or alternatively, the at least one modeled process variable may be the concentration of an excipient in the first solution and/or in the permeate. The modeled process variable may be the concentration of the solute as a function of time, i.e. also the future development of the concentration may be extractable.

According to at least one embodiment, the at least one modeled process variable is a measurable process variable, e.g. a process variable which can be measured during the filtration process with help of a measurement unit. Particularly, a measurable process variable may be a process variable which can be measured in-line and/or in real-time during the filtration process.

According to at least one embodiment, the at least one modeled process variable is the pH value of the first solution and/or of the permeate of the filtration process. Additionally or alternatively, the at least one modeled process variable may be the electrical conductivity of the first solution and/or of the permeate. A further possibility is that the at least one modeled process variable is the absorption of the first solution and/or of the permeate to radiation, e.g. UV radiation, visible light or IR radiation.

The filtration process model may, in particular, model several or all of the herein-mentioned modeled process variables.

According to at least one embodiment, the method further comprises a step in which second measurement data are received. The second measurement data may be indicative for at least one reference process variable. The at least one reference process variable may be a process variable of the filtration process measurable or measured during the filtration process with help of a measurement unit, e.g. in-line and/or in real-time. For example, the at least one reference process variable represents the same process variable as at least one modeled process variable. The at least one reference process variable may be measured only once during the filtration process or may be repeatedly or continuously measured during the filtration process.

According to at least one embodiment, the method comprises a step in which the at least one reference process variable is compared with the at least one modeled process variable.

According to at least one embodiment, the method comprises a step in which at least one parameter of the filtration process model, e.g. of the at least one physical equation, is adjusted based on the comparison in order to adapt the at least one modeled process variable to the at least one reference process variable. For example, when the at least one modeled process variable deviates from the at least one reference process variable by more than a certain threshold, the at least one parameter of the at least one physical equation is adapted.

For example, the at least one reference process variable and the at least one modeled process variable represent the pH value and/or the electrical conductivity and/or the absorption of the first solution and/or of the permeate of the filtration process. The at least one parameter of the model adjusted based on the comparison may be the above-mentioned at least one further parameter of the model, e.g. the composition of the first solution at the beginning of the filtration process and/or the composition of the second solution and/or the charge and/or the surface charge density of a solute.

Additionally or alternatively to adjusting the at least one parameter of the filtration process model based on the comparison, also the filtration process can be adjusted based on this comparison as described above.

According to at least one embodiment, the method comprises a step in which a control signal is generated based on the output data. For example, the control signal is generated automatically based on an automatic analysis of the output data as described above.

According to at least one embodiment, the control signal is configured for controlling at least one controllable process parameter of the filtration process and/or to call for controlling of the at least one controllable process parameter. For example, an actuator may be controlled, e.g. by the control signal. Additionally or alternatively, the control signal may inform a user, e.g. via a computer screen or by an audible indication, that the user should manually control the at least one controllable process parameter or the actuator, respectively. The controllable process parameter may be the (volumetric) flowrate of the permeate and/or of the second solution added to the first solution. Additionally or alternatively, the controllable process parameter may be the duration of one or more steps of the filtration process.

According to at least one embodiment, the filtration process is an ultrafiltration process and/or a diafiltration process. In an ultrafiltration step/process, no second solution is mixed to the first solution. By removing permeate from the first solution, the volume of the first solution is reduced and the at least one product is concentrated in the first solution from its initial concentration to a desired intermediate or final concentration. In a diafiltration process, the second solution is mixed to the first solution. Usually, the flowrate of the second solution mixed to the first solution and the flowrate of the permeate removed from the first solution is chosen to be equal so that the volume of the first solution and with this the concentration of the at least one product in the first solution remains constant. The concentration of the other excipients in the first solution may, however, change.

In an ultrafiltration and diafiltration (UFDF) process, a first ultrafiltration step may be performed in order to concentrate the at least one product from its initial concentration to a desired intermediate concentration. Afterwards, a diafiltration step may be performed, in which the concentration of the at least one product may remain constant while the concentration of other solutes or excipients in the first solution may change. Then, in a second ultrafiltration step, the at least one product is concentrated in the first solution to its final concentration.

According to at least one embodiment, the filtration process is configured to increase and/or decrease the concentration of at least one solute in the first solution. For example, the filtration process is configured to increase the concentration of the at least one product in the first solution.

According to at least one embodiment, at least one solute of the first solution, e.g. the at least one product, is a biological molecule. The biological molecule may be one or more of: a protein, a peptide, a nucleic acid, a virus, a virus fragment.

According to at least one embodiment, at least one further solute of the first solution and/or of the second solution, e.g. an excipient, may be one or more of: an amino acid, a buffer component, a carbohydrate, a salt ion. Particularly, the second solution may comprise a buffer component in order to adjust the pH value of the first solution when mixed to the first solution.

According to at least one embodiment, the at least one input process variable is one or more of: pH value of the first solution (e.g. at the beginning of the filtration process), pH value of the second solution mixed to the first solution during the filtration process (the pH value of the second solution may not change during the filtration process), electrical conductivity of the first solution and/or the second solution, absorption and/or absorbance of the first and/or the second solution, temperature of the first and/or second solution, flowrate of the first solution and/or second solution during mixing to the first solution, information whether the second solution is currently mixed to the first solution or not.

The absorption or absorbance of the first solution and/or second solution may be the absorption/absorbance to UV radiation and/or visible light and/or to IR radiation.

According to at least one embodiment, the method is a computer implemented method. Particularly, some or all steps of the method are executed by a computer or by a processor of the computer.

Next, the device, the computer program and the computer-readable data carrier are specified.

According to at least one embodiment, the device comprises at least one processor configured to perform the method for monitoring a filtration process as specified herein.

According to at least one embodiment, the computer program comprises instructions which, when the program is executed by a computer, cause the computer to carry out the method for monitoring a filtration process as specified herein.

According to at least one embodiment, the computer-readable data carrier comprises instructions which, when executed by a computer, cause the computer to carry out the method for monitoring a filtration process as specified herein.

Next, the filter system for a filtration process is specified. The filter system may be used for the filtration process and for the method for monitoring the filtration process as specified herein. Therefore, all features disclosed in connection with the method for monitoring a filtration process and with the filtration process disclosed herein are also disclosed for the filter system and vice a versa.

According to at least one embodiment, the filter system comprises the device specified herein.

According to at least one embodiment, the filter system comprises at least one measurement unit for measuring a process variable of the filtration process. The measurement unit may be configured for measuring a pH value, e.g. by measuring the electrical conductivity of a solution and/or by measuring an electrical potential difference in a solution, and/or to measure the temperature of a solution and/or to measure the electrical conductivity of a solution and/or to measure an absorption/absorbance of a solution. Particularly, the at least one measurement unit is configured to measure the at least one input process variable and/or the at least one reference process variable specified herein. The filter system may comprise measurement units for several or all of the above-mentioned process variables.

According to at least one embodiment, the filter system comprises a first solution reservoir for storing the first solution.

According to at least one embodiment, the at least one filter system comprises a filter module. The filter module may comprise an inlet fluidically coupled to the first solution reservoir. For example, the first solution reservoir is connected to the inlet of the filter module via a first connection. The filter module may comprise an outlet for removing the permeate of the filtration process. The filter module may comprise a further outlet through which the retentate leaves the filter module. The second outlet may be fluidically connected to the first solution reservoir via a second connection so that the retentate can again be guided into the first solution reservoir.

According to at least one embodiment, the filter system comprises a second solution reservoir for storing the second solution.

According to at least one embodiment, the second solution reservoir is fluidically coupled to the first solution reservoir, e.g. by a third connection. The second solution reservoir may be directly fluidically coupled to the first solution reservoir or indirectly, e.g. via the first or second connection.

According to at least one embodiment, the first and/or the second and/or the third connection may comprise a valve and/or a pump for controlling the (volumetric) flowrate through the respective connection. A valve and/or a pump may be also assigned to the outlet of the filter module in order to control the flowrate of the permeate removed from the filter module.

The one or more measurement units of the filter system may be assigned to the first and/or the second and/or the third connection and/or the outlet of the filter module.

According to at least one embodiment, at least one measurement unit is arranged to measure a process variable of the first solution. For example, the at least one measurement unit is assigned to or located in the first solution reservoir and/or assigned to a located in the first connection. At least one input process variable may be measurable with this measurement unit.

According to at least one embodiment, at least one measurement unit is arranged to measure a process variable of the second solution. For example, this at least one measurement unit is assigned to or located in the second solution reservoir and/or in the third connection between the second solution reservoir and the first solution reservoir. At least one input process variable may be measurable with this measurement unit.

According to at least one embodiment, at least one measurement unit is arranged to measure a process variable of the permeate of the filtration process. This at least one measurement unit may be assigned to the outlet of the filter module. At least one reference process variable may be measurable with this measurement unit.

According to at least one embodiment, at least one measurement unit is assigned to or located in the second connection between the filter module and the first solution reservoir, e.g. in order to measure a process variable of the retentate.

According to at least one embodiment, the filter system comprises at least one actuator for controlling at least one controllable process parameter of the filtration process. For example, the actuator may control a pump and/or valve in the filter system in order to control a flowrate.

According to at least one embodiment, the filter module comprises a cross-flow filtration module and/or a dead-end filtration. The filter module may comprise at least one hollow-fiber membrane and/or at least one flat sheet membrane.

Hereinafter, the method for monitoring a filtration process, the device and the filter system described herein will be explained in more detail with reference to drawings on the basis of exemplary embodiments. Same reference signs indicate same elements in the individual figures. However, the size ratios involved are not necessarily to scale, individual elements may rather be illustrated with exaggerated size for better understanding.

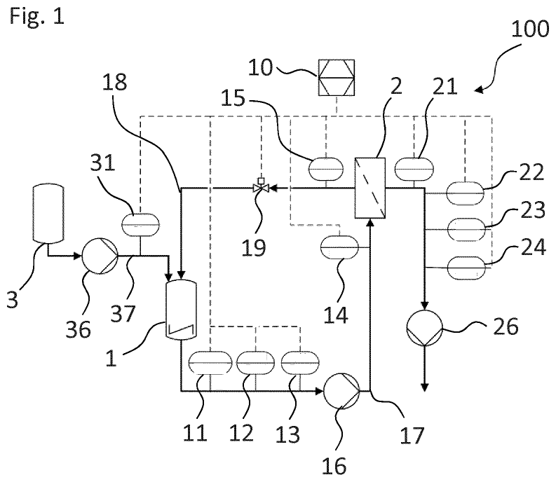

FIG. 1 shows an exemplary embodiment of the filter system,

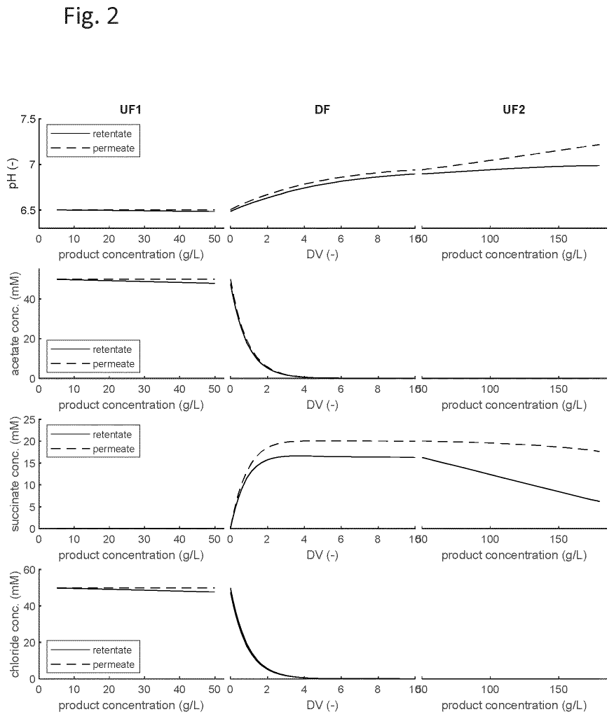

FIG. 2 shows results of an exemplary embodiment of the method for monitoring a filtration process,

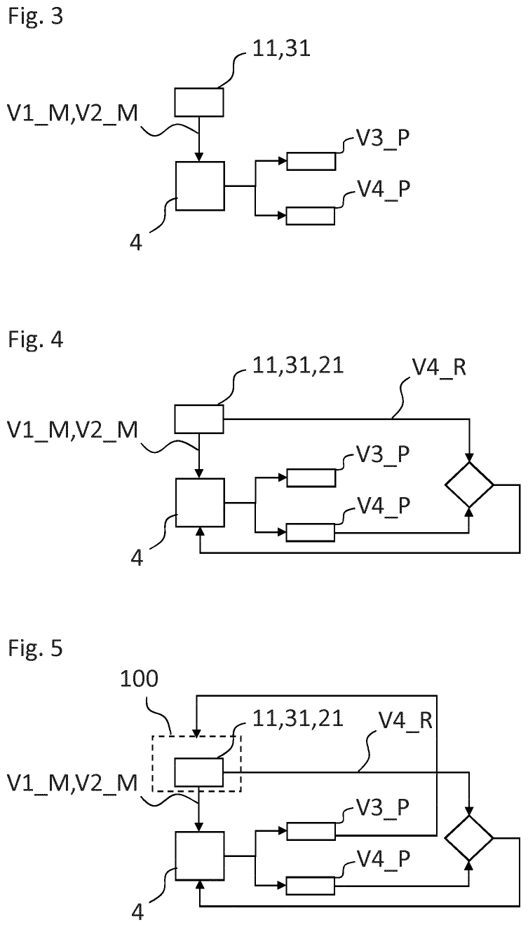

FIGS. 3 to 5 show flowcharts of exemplary embodiments of the method for monitoring a filtration process.

FIG. 1 shows an exemplary embodiment of a filter system 100 for a filtration process. The filter system 100 comprises a first solution reservoir 1 for storing a first solution, a filter module 2 and a second solution reservoir 3. The first solution reservoir 1 is fluidically connected to an inlet of the filter module 2 via a first connection 17. Several measurement units 11, 12, 13, 14 are assigned to the first connection 17. Measurement unit 11 may be a pH sensor for measuring the pH value of the first solution flowing through the first connection 17. Measurement unit 12 may be a conductivity sensor for measuring the electrical conductivity of the first solution flowing through the first connection 17. Measurement unit 13 may be an absorption/absorbance sensor for measuring the absorption/absorbance of radiation, e.g. of UV radiation or visible light or IR radiation, by the first solution flowing through the first connection 17. Measurement unit 14 may be a pressure sensor for measuring the pressure of the first solution in the first connection 17. A pump 16 is assigned to the first connection 17 and may control the flowrate of the first solution pumped from the first solution reservoir 1 to the filter module 2. Additionally, there may be a measurement unit in form of flowmeter for measuring the flowrate of the first solution flowing through the first connection 17.

The filter module 2 may comprise a semipermeable membrane. The semipermeable membrane may be configured to let a solvent of the first solution and some solutes, e.g. excipients, in the first solution pass but to retain a dissolved product in the first solution. The filter module 2 comprises an outlet for removing the permeate passing through the semipermeable membrane. Measurement units 21, 22, 23, 24 are assigned to this outlet or to a connection from this outlet, respectively. Measurement unit 21 may be a pH sensor for measuring the pH value of the permeate, measurement unit 22 may be configured to measure the pressure of the permeate, measurement unit 23 may be a conductivity sensor for measuring the electrical conductivity of the permeate and measurement unit 24 may be a flowmeter for measuring the flow rate of the permeate. A pump 26 is assigned to the outlet of the filter module 2 in order to remove the permeate.

The filter module 2 comprises a further outlet through which the retentate leaves the filter module. The further outlet is fluidically connected to the first solution reservoir 1 via a second connection 18 through which the retentate is guided into the first solution reservoir 1. A measurement unit 15 in form of a pressure sensor and/or a flowmeter are assigned to the second connection 18. Furthermore, a valve 19 is assigned to the second connection 18.

A second solution reservoir 3 for storing a second solution is fluidically connected to the first solution reservoir 1 via a third connection 37. The second solution may be guided through the third connection 37 into the first solution reservoir 1. A measurement unit 31, e.g. in form of a pH sensor or conductivity sensor or absorption sensor or pressure sensor or flowmeter may be assigned to the third connection 37. It is also possible to use two or more of the mentioned sensors for measuring properties of the second solution. Furthermore, a pump 36 is assigned to the third connection 37 in order to pump the second solution from the second solution reservoir 3 into the first solution reservoir 1.

As can be seen in FIG. 1, measurement signals or measurement data, respectively, measured with the different measurement units are received by a device 10. The device 10 may comprise at least one processor for performing the method for monitoring a filtration process as described herein.

The filter system 100 shown in FIG. 1 may be a filter system for performing an ultrafiltration and diafiltration (UFDF) process. At the beginning of the filtration process, an initial first solution is stored in the first solution reservoir 1 and a second solution is stored in the second solution reservoir 3. The initial first solution may comprise a dissolved product. The product may be biological molecule, like a protein, a peptide, a nucleic acid or a virus. Besides the product, the initial first solution may comprise further solutes, like amino acids, carbohydrates and/or salt ion. The second solution may comprise a solute in form of a buffer component.

In a first ultrafiltration step, no second solution is pumped into the first solution reservoir 1. The initial first solution is pumped from the first solution reservoir 1 to the filter module 2. The semipermeable membrane of the filter module 2 may allow some of the solutes but the product to pass. A permeate comprising the passed solutes can be pumped away with help of the pump 26. The remainder of the first solution (retentate) which has not passed through the semipermeable membrane comprises the product and is guided back to the first solution reservoir 1. The retentate gradually replaces the initial first solution so that that the composition of the first solution changes. During this ultrafiltration step, the concentration of the product in the first solution is increased.

After that, a diafiltration step may be performed in which the second solution containing the buffer component is pumped into the first solution reservoir 1 with help of the pump 36 and is mixed to the first solution. At the same time, the first solution is pumped from the first solution reservoir 1 through the filter module 2. For example, the flowrate of the second solution pumped into the first solution reservoir 1 is the same as the flowrate of the permeate pumped away from the filter module 2 with help of the pump 26. Thus, the volume of the first solution containing the product remains constant. Moreover, when the flowrates are equal, also the concentration of the product in the first solution remains constant. However, the composition of the first solution containing the products changes due to removal of the permeate containing solutes and the adding of the second solution containing the buffer component.

After the diafiltration process, a second ultrafiltration step may be performed, in which again no second solution is pumped into the first solution reservoir 1 but only permeate is removed. In this step, the product may be concentrated in the first solution to its final concentration.

The device 10 may be configured to perform the method for monitoring the filtration process. An exemplary embodiment of the method is as follows: In one step, first measurement data are received by the device 10. The first measurement data are indicative for at least one input process variable, e.g. for the pH value of the second solution and the pH value of the first solution at the beginning of the filtration process, i.e. the pH value of the initial first solution. In a further step of the method, output data are determined by executing a filtration process model 4 using the first measurement data. The execution of the filtration process model 4 comprises solving a physical equation describing the interaction between the solutes of the first solution, wherein at least one parameter of the process filtration model, e.g. of the physical equation, is dependent on the at least one input process variable extractable from the first measurement data. The output data are indicative for at least one modeled process variable of the filtration process, e.g. for the concentration of the product in the first solution and/or the pH value of the permeate as a function of time.

An exemplary embodiment of the filtration process model 4 may be as follows:

### 1. Mass Balance

The filtration process model 4 may predict the concentration of solutes in the retentate/first solution by solving global mass balance equations for the filter system 100. The mass balance equations are solved based on measurements in the second solution and in the first solution. The mass balance equations consider interactions between the product and other solutes, e.g. excipients.

Solution streams going in and out of the filter module 2 are considered to contain small solutes like buffer substances, carbohydrates, and amino acids with a concentration cᵢ. The product, e.g. a protein, on the other hand, cannot pass through the semipermeable membrane and, therefore, is fully retained in the retentate. The product concentration c_{M} in the retentate is therefore defined by the mass balance

$$\frac{{dc}_{M} ( t )}{dt} = - \frac{{c}_{M} ( t )}{{V}_{Ret} ( t )} ( {Q}_{DF} ( t ) - {Q}_{Perm} ( t ) ) , \qquad ( 1 )$$

where t represents the process time, V_{Ret} is the total retentate volume within the system, Q_{DF} is the flowrate of the second solution added to the first solution, and Q_{Perm} is the flowrate of the permeate. The index “Ret” is herein used for the retentate/first solution, the index “DF” is used for the second solution and the index “Perm” is used for the permeate. The flowrates Q_{DF} and Q_{Perm} can be measured, for instance, using flowmeters. The temporal change of V_{Ret} is defined by the balance

$$\frac{{dV}_{Ret} ( t )}{dt} = {Q}_{DF} ( t ) - {Q}_{Perm} ( t ) . \qquad ( 2 )$$

During ultrafiltration, no second solution is added to the first solution (Q_{DF}=0) and the product is concentrated. During diafiltration, the volumetric flowrate of the second solution is assumed to be equal the volumetric flowrate of the permeate (Q_{DF}=Q_{Perm}) and V_{Ret} is constant.

Small solutes, particularly excipients, like buffer components and amino acids in the first solution are not retained by the filter module 2 and can leave the filter system 100 via the outlet of the filter module 2 as described by

$$\frac{{dc}_{Ret , i} ( t )}{dt} = \frac{{Q}_{DF} ( t )}{{V}_{Ret} ( t )} ( {c}_{DF , i} ( p {H}_{DF} ) - {c}_{Ret , i} ( t ) ) - \frac{{Q}_{Perm} ( t )}{{V}_{Ret} ( t )} ( {c}_{Perm , i} ( t , {c}_{M} , {c}_{Ret} , p {H}_{Ret} ) - {c}_{Ret , i} ( t ) ) . \qquad ( 3 )$$

Solving the ordinary differential equations above, the product concentration c_{M}(t), the first solution volume V_{Ret}(t), and the excipient concentrations c_{Ret,i}(t) can be described as a function of the process time. The concentration of the excipients inside the permeate

$${c}_{Perm , i} = f ( t , {c}_{M} , {c}_{Ret} , p {H}_{Ret} ) \qquad ( 4 )$$

is thereby a function of the current concentrations in the retentate c_{Ret}, the product concentration c_{M}, and the pH value in the retentate pHᵣₑₜ. The concentration of an excipient inside the second solution

$${c}_{DF , i} = f ( p {H}_{DF} ) \qquad ( 5 )$$

may be a function of the measured pH value in the second solution (pH_{DF}).

### 2. Composition of Solutions

The filtration process model 4 may use the pH value of the second solution, equilibrium equations, and the conditions of electroneutrality in the second solution reservoir 3 to determine the composition of the second solution mixed to the first solution via pump 36. Likewise, the composition of the first solution can be determined. Therefore, the following formulas are applicable for the first solution as well.

The second solution (as well as the first solution and the permeate) may contain various solutes, particularly excipients, such as buffer components, amino acids and salts. Depending on the pH value, some of these excipients can be present in different protonation states and thus ionized forms. Therefore, the exact ion composition of the second solution depends on the pH value. Considering, for instance, a second solution that contains a buffer component i with known total concentration cᵢ. The buffer component possesses n dissociation sites. In this case, the buffer component i itself can be present in n+1 ionization states. Thus, the total concentration of buffer component i is equal to

$${c}_{i} = {\sum }_{j = 1}^{n + 1} {c}_{i , j} ( p H ) , \qquad ( 6 )$$

where c_{i,j} is a function of the pH value. The first ionization state j=1 denotes the fully protonated state indicated by HₙA^{m}, where m represents the charge of the fully protonated state. Considering the general dissociation reaction of the buffer substance

$${H}_{n - j + 1} {A}^{m - j + 1} ⇋ {H}_{n - j} {A}^{m - j} + {H}^{+} \qquad ( 7 )$$

and its equilibrium constant

$${K}_{j}^{*} = \frac{[ {H}_{n - j} {A}^{m - j} ]}{[ {H}_{n - j + 1} {A}^{m - j + 1} ]} 1 {0}^{- p H} , \qquad ( 8 )$$

the concentrations of the ionization states are defined by the measured pH value according to

$${c}_{i , 1} ( p H ) = {{c}_{i} ( 1 {0}^{- p H} )}^{n} {( {( 1 {0}^{- p H} )}^{n} + {\sum }_{k = 1}^{n} {( 1 {0}^{- p H} )}^{n - k} {\sum }_{l = 1}^{k} {K}_{l}^{*} )}^{- 1} \qquad ( 9 )$$

$$and$$

$${c}_{i , j} ( p H ) = {{c}_{i} ( 1 {0}^{- p H} )}^{n - j + 1} {\prod }_{k = 1}^{j - 1} {{K}_{k}^{*} ( {( 1 {0}^{- p H} )}^{n} + {\sum }_{k = 1}^{n} {( 1 {0}^{- p H} )}^{n - k} {\sum }_{l = 1}^{k} {K}_{l}^{*} )}^{- 1} , j = 2 … n + 1 . \qquad ( 10 )$$

In the second solution, the charge of all ionized forms is balanced by counter-ions. The concentration of these counter-ions entering the mass balance equation above is not known but can be derived from the condition of electroneutrality in the second solution reservoir 3. If the charge of the j-th ionization state is denoted by z_{i,j}, the concentration of counter-ions c_{c} results from the electroneutrality condition

$${c}_{C} ( {p H}_{D F} ) = \vert {\sum }_{i} {\sum }_{j} {z}_{i , j} {c}_{i , j} ( {p H}_{D F} ) \vert .$$

### 3. Product-Excipient Interaction

The filtration process model 4 may use the Poisson-Boltzmann equation to describe interactions between the product and smaller solutes (excipients) in the first solution.

If we assume that the retentate/first solution and the permeate are in thermodynamic equilibrium (Donnan equilibrium), the relationship c_{Perm,i}=f (t, c_{M}, c_{Ret}, PH_{Ret}) in the mass balance above is given by the Boltzmann relation

$${c}_{P erm , i} = {\sum }_{j} \frac{{c}_{R e t , i , j}}{1 - Θ} exp ( {z}_{i , j} \frac{e \overline{ψ} ( {c}_{M ,} {c}_{Ret ,} {p H}_{r e t} )}{{k}_{b} T} ) , \qquad ( 11 )$$

where ψ̅ is the average electrostatic potential in the first solution, k_{b} represents the Boltzmann constant, T is the absolute temperature, N_{A} is the Avogadro number, and

$$Θ = \frac{4}{3} π {a}_{M}^{3} {c}_{M} {N}_{A} \qquad ( 12 )$$

describes the volume fraction of the first solution occupied by the product with known radius a_{M}. The product z_{i,j}eψ̅ in the exponent is a measure for the interaction between an excipient and the product. If the term is positive, the excipient is repelled by the product. If the term is negative, the excipient is attracted by the product and retained within the retentate. The average electrostatic potential ψ̅ can be interpreted as the Donnan potential describing the unequal solute concentration distribution across the membrane due to interactions between the product and other solutes. It must suffice the electroneutrality condition on the permeate side

$$0 = {\sum }_{i} {\sum }_{j} {z}_{i , j} {c}_{P e r m , i , j} = {\sum }_{i} {\sum }_{j} {z}_{i , j} \frac{{c}_{R e t , i , j}}{1 - Θ} exp ( {z}_{i , j} \frac{e \overline{ψ} ( {c}_{M ,} {c}_{Ret ,} {p H}_{r e t} )}{{k}_{b} T} ) \qquad ( 13 )$$

and the Poisson-Boltzmann equation on the retentate side

$$\frac{{\partial }^{2} ψ ( r )}{\partial {r}^{2}} + \frac{2}{r} \frac{\partial ψ ( r )}{\partial r} = - \frac{e}{ε {ε}_{0}} {\sum }_{i} {z}_{i} \frac{{c}_{R e t , i}}{1 - Θ} exp ( \frac{{z}_{i} e}{{k}_{b} T} ( ψ ( r ) - \overline{ψ} ) ) . \qquad ( 14 )$$

The Poisson-Boltzmann equation may be solved using the cell model. Within the cell model, the first solution is reduced to a single Wigner-Seitz (WS) cell containing one product molecule at its center. The WS cell may be spherical in shape. In this case, the radius of the WS cell R_{WS} is defined by the product concentration according to

$${R}_{w s} = {( \frac{3}{4 π {N}_{A} {c}_{M}} )}^{\frac{1}{3}} . \qquad ( 15 )$$

Using the cell model, the Poisson-Boltzmann equation can be solved numerically using the boundary condition

$$\frac{\partial ψ}{\partial r} {\vert}_{r = {a}_{M}} = - \frac{e {z}_{M} ( {p H}_{r e t} )}{4 π {a}_{M}^{2} ε {ε}_{0}} \qquad ( 16 )$$

at the surface of the product molecule, and the condition

$$\frac{\partial ψ}{\partial r} {\vert}_{r = R w s} = 0 \qquad ( 17 )$$

at R_{WS}, where z_{D} represents the net charge of the product molecule. Solving the Poisson-Boltzmann equation leads to ψ̅(c_{M}, c_{Ret}, PHᵣₑₜ) and thus c_{Perm,i}=f (t, c_{M}, c_{Ret}, PH_{Ret}) for the mass balance equation.

### Product Charge

The filtration process model 4 calculates the charge of the product z_{M}(pHᵣₑₜ) used in the Poisson-Boltzmann equation above based on the known primary sequence when the product is a protein.

The net charge of the protein z_{M} can be derived theoretically from the known primary sequence of the protein. Proteins are biopolymers which are based on amino acids as building blocks. The order in which the amino acids are arranged in the polypeptide chain defines the protein's primary sequence. The net charge depends on the number of ionizable amino acids in the primary sequence and their pKa values. Considering an ionizable amino acid side chain j with charge ζⱼ of the protonated form HA^{ζ}i, the dissociation reaction

$${H A}^{{ζ}_{j}} ⇌ {A}^{{ζ}_{j} - 1} + {H}^{+}$$

is defined by the equilibrium constant of the amino acid

$${K}_{j} = 1 {0}^{- pKj} = \frac{[ {A}^{{ζ}_{j} - 1} ]}{[ {H A}^{{ζ}_{j}} ]} 1 {0}^{- p H} ,$$

whereby square brackets depict molar concentrations. The ionizable amino acids may, e.g., include arginine, histidine, lysine, aspartic acid, and glutamic acid. In this case, z_{M} is defined by

$${z}_{M} ( {p H}_{r e t} ) = {\sum }_{j} {N}_{j} \frac{{ζ}_{j} + ( {ζ}_{j} - 1 ) 1 {0}^{{p H}_{0} - {pK}_{j}}}{1 + 1 {0}^{{p H}_{0} - p {K}_{j}}} , \qquad ( 18 )$$

where Nⱼ denotes the number of the j-th ionizable side chain in the primary sequence and pH₀ is the pH-value at the surface of the protein defined by

$${p H}_{0} = {p H}_{r e t} + \frac{1}{ln ( 10 )} \frac{e}{{k}_{b} T} ( ψ ( {a}_{M} ) - \overline{ψ} ) . \qquad ( 19 )$$

FIG. 2 shows modeled process variables extracted from the output data obtained by using this filtration process model 4. The filtration process model 4 was applied to describe the ultrafiltration and diafiltration (UFDF) process of the protein glucose oxidase as the product of the first solution. The charge of the product glucose oxidase was calculated using the following table:

| Amino acid | Quantity | pK value |
|---|---|---|
| Lysine | 30 | 10.4 |
| Arginine | 44 | 12.0 |
| Histidine | 38 | 6.3 |
| Glutamic acid | 60 | 4.4 |
| Aspartic acid | 72 | 4.0 |
| tyrosine | 54 | 9.6 |
| N termini | 2 | 7.5 |
| C termini | 2 | 3.8 |

At the beginning of the UFDF process, the protein was dissolved in 50 mM sodium acetate buffer with 50 mM sodium chloride (pH 6.5). The initial protein concentration in the initial first solution was 5 g/L. During a first ultrafiltration step (UF1), the protein was concentrated to an intermediate concentration of 50 g/L. Afterwards, the protein was diafiltrated over 10 diavolumes (DV) using 20 mM succinate as the second solution (pH 7.0). In a second ultrafiltration step (UF2), the first solution was concentrated to a final protein concentration of 180 g/L.

The ordinary differential equations (ODEs) Eq. (1)-Eq. (3) were solved in MATLAB (The Mathworks, Natick, Massachusetts, USA) using the ODE solver ode15s. At every time step, pHᵣₑₜ and ψ̅ were determined iteratively so that ψ̅ is in compliance with both the electroneutrality condition in the permeate [Eq. (13)] and the Poisson-Boltzmann equation in the first solution [Eq. (14)]. First, pHᵣₑₜ was guessed and used to determine the concentrations of microions c_{Ret,i},j is the retentate/first solution according to the buffer equilibrium Eq. (9)-Eq. (10). Knowing c_{Ret,i,j}, ψ̅ was determined to suffice the electroneutrality condition on the permeate side [Eq. (13)]. Afterwards, the Poisson-Boltzmann equation within the WS cell was solved using Eq. (18) for z_{M} of glucose oxidase. Using for example a regula falsi approach, the unknown pHᵣₑₜ can be varied until ψ̅ sufficed both the electroneutrality condition [Eq. (13)] and the Poisson-Boltzmann equation within the WS cell. Alternatively, the pH in the first solution pHᵣₑₜ can be derived from measurement data that are indicative for pHᵣₑₜ.

The filtration process model 4 of this exemplary embodiment determines output data which are indicative for the modeled process variable which are: the pH values of the permeate and the retentate and concentrations of different solutes.

The upper picture of FIG. 2 shows the pH values of the permeate (dashed line) and the retentate (solid line) as a function of the product concentration in the retentate or first solution. As the product concentration increases with time during the filtration process, the x-axis also represents a time axis. The different steps of the filtration process UF1, DF, and UF2 are also indicated.

In the second picture of FIG. 2, the concentration of an excipient, namely of acetate, in the permeate (dashed line) and the retentate (solid line) as a function of the product concentration in the retentate is shown.

In the third picture of FIG. 2, the concentration of an excipient, namely of succinate, in the permeate (dashed line) and the retentate (solid line) as a function of the product concentration in the retentate is shown.

In the fourth picture of FIG. 2, the concentration of an excipient, namely of chloride, in the permeate (dashed line) and the retentate (solid line) as a function of the product concentration in the first retentate is shown.

FIG. 3 shows a flowchart of an exemplary embodiment of the method for monitoring a filtration process. The filtration process is, e.g., done with the filter system 100 of FIG. 1. First measurement data which are indicative for two input process variables V1_M, V2_M measured with help of two measurement units 11, 31 are received and used as an input for the filtration process model 4. The input process variables may be, e.g., the pH value of the second solution V2_M and the pH value of the first solution V1_M at the beginning of the filtration process. However, also additional or other input process variables, like the electrical conductivity and/or the absorption of the first solution and the second solution may be used. The filtration process model 4 is, e.g., the model as described before. Parameters of this filtration process model 4 dependent on the input process variables V1_M, V2_M.

With help of the filtration process model 4, output data are generated which are indicative for modeled process variables V3_P, V4_P. The modeled process variable V3_P may be, e.g., the concentration of the product and/or excipients in the first solution as a function of time. The modeled process variable V4_P may be, e.g., the pH value of the retentate and/or of the permeate (see also first picture of FIG. 2). Additionally or alternatively, the modeled process variable V4_P could be the absorption and/or the electrical conductivity of the permeate and/or retentate. The modeled process variables may, e.g., be displayed on a screen. A user may then study the modeled process parameters V3_P, V4_P.

FIG. 4 shows a flowchart of a further exemplary embodiment of the method for monitoring a filtration process. The method is similar to the one described in connection with FIG. 3. However, in FIG. 4, second measurement data are additionally received which are indicative for a reference process variable V4_R measured with the measurement unit 21. The reference process variable V4_R may be, e.g., the pH value of the permeate at a certain time during the filtration process. In a further step of the method, the modeled process variable V4_P at that certain time may now be compared with the reference process variable V4_P. Based on this comparison, the filtration process model 4 may be adapted. For example, a parameter of the filtration process model, e.g. the assumption about the composition of the first solution at the beginning of the filtration process and/or of the second solution is adapted based on this comparison. In this way, the modeled process variable V4_P can be adapted to the reference process variable V4_R. In this way, the filtration process model 4 can be optimized during the filtration process in order to better describe the actual measured reference process variable(s).

FIG. 5 shows yet another exemplary embodiment of the method for monitoring a filtration process. This exemplary embodiment is similar to the one of FIG. 4. However, in case of FIG. 5, a control signal is generated based on the output data of the model 4, particularly based on the modeled process variable V3_P. For example, the modeled process variable V3_P represents the concentration of the product or another solute in the first solution and/or in the permeate as a function of time. The modeled process variable V3_P may be compared to a desired concentration of the product or the solute during or at the end of the filtration process. This comparison may be done automatically, e.g. by the device 10. If the deviation between the modeled process variable V3_P and the desired value exceeds a certain threshold, a control signal may be generated in order to adjust the filtration process or in order to call for an adjustment of the filtration process. The generation of the control signal may also be done by the device 10. For example, the control signal may be used to control a controllable process parameter and/or an actuator of the filter system 100. By way of example, the controllable process parameter may be the time of the different filtration steps UF1, DF, UF2 and/or the flowrate with which the permeate is removed from the filter module 2 and/or the flowrate with which the second solution is mixed to the first solution during the diafiltration step DF. This may be done by controlling at least one of the pumps 26 and 36 and/or the valve 19. Also, the controlling of the pump(s) may be done automatically.

The invention described herein is not limited by the description in conjunction with the exemplary embodiments. Rather, the invention comprises any new feature as well as any combination of features, particularly including any combination of features in the patent claims, even if said feature or said combination per se is not explicitly stated in the patent claims or exemplary embodiments.

### REFERENCE NUMBER LIST

1 first solution reservoir
2 filter module
3 second solution reservoir
4 filtration process model
10 device
11, . . . , 15 measurement unit
16 pump
18 second connection
21, . . . , 24 measurement unit
26 pump
31 measurement unit
36 pump
37 third connection
100 filter system
V1_M, V2_M input process variable
V3_P, V4_P modeled process variable
V4_R reference process variable
UF1 first ultrafiltration step
UF2 second ultrafiltration step
DF diafiltration step

1. Method for monitoring a filtration process in which a first solution is processed by a filter system, the method comprising
receiving first measurement data which are indicative for at least one input process variable, wherein the at least one input process variable is a process variable of the filtration process measurable during the filtration process with help of a measurement unit,
determining output data by executing a filtration process model and using the first measurement data, wherein
executing the filtration process model comprises solving at least one physical equation describing the interaction between solutes of the first solution,
at least one parameter of the filtration process model is dependent on the at least one input process variable derived from the first measurement data,
the output data is indicative for at least one modeled process variable of the filtration process.

2. Method according to claim 1,
further comprising analyzing the output data in order to adjust the filtration process when necessary and/or
wherein determining the output data is done during the filtration process and/or in real time.

3. Method according to claim 1, wherein
the at least one physical equation is based on the Poisson-Boltzmann equation.

4. Method according to claim 1, wherein
the filtration process model is based on a cell model approach,
in the cell model approach, the first solution is reduced to a single Wigner-Seitz cell containing one molecule of a product of the first solution in its center,
the radius R_{WS} of the Wigner-Seitz cell is defined by the concentration of the product c_{M} in the first solution and is
$${R}_{w s} = {( \frac{3}{4 π {N}_{A} {c}_{M}} )}^{\frac{1}{3}}$$
with N_{A} being the Avogadro constant.

5. Method according to claim 1, wherein
at least one further parameter of the filtration process model is dependent on
the composition of the first solution and/or of a second solution mixed to the first solution during the filtration process, and/or
the charge and/or surface charge density of a solute in the first solution.

6. Method according to claim 1, wherein
the at least one modeled process variable extractable from the output data is the concentration of a solute of the first solution and/or of a permeate of the filtration process, and/or
the at least one modeled process variable is a measurable process variable, and
the at least one modeled process variable is the pH value of the first solution and/or of a permeate of the filtration process.

7. Method according to claim 1, further comprising
receiving second measurement data which are indicative for at least one reference process variable, wherein the at least one reference process variable is a process variable of the filtration process measurable during the filtration process with help of a measurement unit and representing the same process variable as at least one modeled process variable,
comparing the at least one reference process variable with the at least one modeled process variable,
adjusting at least one parameter of the filtration process model based on the comparison in order to adapt the at least one modeled process variable to the at least one reference process variable.

8. Method according to claim 1, further comprising
generating a control signal based on the output data, wherein
the control signal is configured for controlling at least one controllable process parameter of the filtration process and/or to call for controlling of the at least one controllable process parameter.

9. Method according to claim 1, wherein
at least one solute of the first solution is a biological molecule comprising at least one of: a protein, a peptide, a nucleic acid, a virus.

10. Method according to claim 1, wherein the at least one input process variable is at least one of:
pH value of the first solution,
pH value of a second solution mixed to the first solution during the filtration process,
electrical conductivity of the first solution and/or the second solution,
absorption and/or absorbance of the first solution and/or second solution,
temperature of the first solution and/or second solution,
flowrate of the first solution and/or of the second solution during mixing to the first solution,
information whether the second solution is currently mixed to the first solution or not.

11. Device comprising a processor configured to perform the method of claim 1.

12. Computer program comprising instructions which, when the program is executed by a computer, cause the computer to carry out the method according to claim 1.

13. Computer-readable data carrier comprising instructions which, when executed by a computer, cause the computer to carry out the method according to claim 1.

14. Filter system for a filtration process comprising:
a device according to claim 11,
at least one measurement unit for measuring a process variable of the filtration process,
a first solution reservoir for storing the first solution,
a filter module with an inlet fluidically coupled to the first solution reservoir and an outlet for removing a permeate of the filtration process.

15. Filter system according to claim 14, further comprising
a second solution reservoir for storing a second solution, wherein
the second solution reservoir is fluidically coupled to the first solution reservoir,
at least one measurement unit is arranged to measure a process variable of the first solution, and
at least one measurement unit is arranged to measure a process variable of the permeate of the filtration process.
